(19) United States
(12) Patent Application Publication
(10) Pub. No.: US 2002/0091658 A1
(43) Pub. Date: Jul. 11, 2002

(54) Multimedia electronic education system and method

(76) Inventor: Jung-Hoon Bae, Seoul (KR)

Correspondence Address: KLAUBER & JACKSON, 411 HACKENSACK AVENUE, HACKENSACK, NJ, 07601

(21) Appl. No.: 09/938,363

(22) Filed: Aug. 24, 2001

(30) Foreign Application Priority Data
Aug. 25, 2000 (KR) 2000-49668
Jul. 12, 2001 (KR) 2001-42980
Aug. 14, 2001 (KR) 2001-49016

(51) Int. Cl. G06F 15/18

(52) U.S. Cl. 706/62; 706/25

(57) ABSTRACT

The present invention relates to an education system and, more particularly, to a multimedia electronic education system and method wherein a learner can download and execute a lecture file or take a lecture in real-time, then lecture notes can be prepared and re-played during off-line time. According to the present invention, a lecturer and a plurality of learners can simultaneously connect on-line with one another and bi-directionally transfer multimedia information in real-time. The contents of a real-time lecture or presentation can be recorded and stored in a file, which in turn can be edited and modified. Events can occur on scheduled time upon playing the contents back by setting functions including the assignment of the permission to speak for questions and answers, chatting by means of voice and texts, and sharing a screen, and start times, end times or durations of all events employed in the contents during the progression of the lecture.

### CLAIM OF PRIORITY

This application makes reference to, incorporates the same herein, and claims all benefits accruing under 35 U.S.C. § 119 arising from an application entitled, “MULTIMEDIA ELECTRONIC EDUCATION SYSTEM AND METHOD,” filed earlier in the Korean Industrial Property Office on Aug. 25, 2000, Aug. 14, 2001, and Jul. 12, 2001, and there duly assigned Ser. Nos. 2000-49668, 2001-49016, and 2001-42980, respectively.

### BACKGROUND OF THE INVENTION

1. Field of the Invention

The present invention relates generally to the field of education and, more particularly, to a multimedia electronic education system and method that can provide both on-line and off-line learning experiences.

2. Description of the Prior Art

In a conventional multimedia educational environment, a user typically inserts a CD into the CD-ROM drive of a PC to execute learning programs. The CD storage capacity is adequate for a relatively large amount of data and motion video signals. However, if there is a change in the latest educational information stored in the CD, the CD must be replaced. In addition, if the educational content of the CD is conveyed to the user without the ability to interact with the instructor, it is difficult to achieve a meaningful learning experience.

With the advent of the Internet, on-line educational services have become popular. It is now possible to solve the drawbacks of updating the latest information, as discussed earlier. However, most on-line services do not have the capability to provide interaction between the user and the instructor.

In the production of educational contents according to the prior art, voice is typically recorded in real time. If any simulation or events, such as highlighting, writing certain marks and reference information, underlining important matters, and other activities associated with a typical lecture environment. Occurs during the recording of the voice in real time, it is difficult to perform simultaneous inputs of the events with the recording of voice signals in the prior art system. Thus, the events cannot occur simultaneously with the live video signals. Moreover, if the contents are produced by a real-time recording program, a mechanism for editing the events during a lecture is not provided in the prior art system. If the events are inputted in non-real time, respective event data do not have relevant time values to synchronize with the live video signals. Therefore, if an operator wishes to generate a specific event during a scheduled time after the recording of a lecture session, the operator must manually generate the specific event to be recorded within the duratio of already recorded session, by operating a keyboard, mouse or the like on a computer. If the operator wishes to generate other events at a certain time during the event, it is difficult to insert another event as the respective events do not have start or end time values in the prior art; thus, overlapped events occurs. That is, there is no time reference for a new event to follow to avid interfering other events. Accordingly, it is difficult to select and process a desired event among the overlapped events.

In addition, if a remote video conference, education, or presentation progresses in real time and the ongoing contents are recorded and played back in real time, as most prior art systems do not have capability to edit the recorded program during the real-time progression, there is no alternative but to play back the contents as they were recorded with errors. Furthermore, when attempting to arbitrarily switch pages of the recorded lecture to a specific page during playback, the conventional systems can switch only the pages but cannot playback a desired portion of the contents as the switched page is not synchronized with voice data corresponding to the time value of the switched page. Thus, the previous voice data continues to be played back such that the voice data and the contents of the page progress separately.

Accordingly, there is a need for a system to provide enhanced interactive features that are not realized in the prior art systems so that the user may benefit active learning from the on-line education services.

### SUMMARY OF THE INVENTION

The present invention is directed to provide a multimedia electronic education system and method, wherein an educational lecture can progress in real time while the contents of the lecture can be recorded and stored, then the stored contents can be edited in non-real time.

Another aspect of the present invention provides a multimedia electronic education system and method, wherein certain events can occur at a later scheduled time upon replay by setting functions, including the assignment of the permission to speak for questions and answers, chatting by voice and texts, sharing a screen during the lecture.

The multimedia electronic education system according to the present invention includes: a plurality of the client's PCs for the lecturer and the students; a recording server for recording a real-time lecture and for automatically converting the recorded lecture into a format capable of being used for a non-real-time remote program and then storing it; an MDBM (Multimedia Data Broadcasting Module) server for connecting the plurality of the client's PCs to each other and for broadcasting data transferred during the progression of the real-time lecture to all of the client's PCs and the recording server; and, a management server for transmitting lecture notes to the client's PCs and the recording server, and for performing user authentication.

Another aspect of the present invention provides, as for the production of the lecture, a multimedia electronic education method for generating a lecture file using the recorder of a lecture-producing program by a lecturer. The method includes the steps of preparing an event list while counting the lecture time; if the lecturer's voice is inputted, generating a voice file together with information on the counted lecture time; upon the input of an event, storing start or end time and the type of the event in the event list; and, synchronizing the voice file with the events registered in the event list according to the information on the lecture time, and for separately or integrally storing the voice file and the events.

Another aspect of the present invention provides a multimedia electronic education method, which includes the steps of: loading a lecture file and checking the overall lecture time; generating a time table array having a size corresponding to the overall lecture time; searching start and end times of all events in an event list; generating an event data structure in the time table array corresponding to the periods of the events' existence according to the start and end times of all events; storing the addresses of the event data structure in the time table array; generating a start and end event array in the event data structure; storing relevant start and end event addresses in the start and end event array; and, if there are addresses of the event data structure in the time table array corresponding to the lecture time while increasing the lecture time, loading the event of relevant start and end event addresses stored in the start event array and the end event array of the event data structure, then starting or ending the event.

### BRIEF DESCRIPTION OF THE DRAWINGS

FIG. 1 is an overall view of the peripheral devices of a multimedia electronic education according to the present invention.

FIG. 2 is an explanatory view illustrating the function of a management server.

FIG. 3a is an explanatory view illustrating the connection relationships among an MDBM server, a recording server, and respective clients.

FIG. 3b is an explanatory view illustrating the data pattern, which the MDBM transmits and receives to and from the respective clients and the recording server.

FIG. 3c is an explanatory view illustrating the data pattern that the lecturer I, the clients C, and a specific client SC transmit.

FIG. 4 is an explanatory view illustrating the process of transmitting data from every client to the MDBM server.

FIG. 5 is an explanatory view illustrating the process of broadcasting the contents of a real-time lecture to the clients.

FIG. 6 is an explanatory view illustrating the process of processing data received from the MDBM server and the management server by the recording server.

FIG. 7 is an explanatory view illustrating the environment for connecting the clients to the MDBM server.

FIG. 8a is an explanatory view illustrating the process of producing and editing audio clips, inserting video data files, and storing a lecture file using the recorder of a non-real-time lecture-producing program.

FIG. 8b is an explanatory view illustrating the method of producing and providing a download-type lecture.

FIG. 8c is an explanatory view illustrating the method of producing and providing a streaming-type lecture.

FIGS. 9 and 10 are views illustrating the user interfaces configured by the programs for the lecturer and student of a real-time remote education program, respectively.

FIGS. 11 and 12 are explanatory views illustrating the recorder and the player of a non-real-time remote education program.

FIG. 13 is an explanatory view illustrating the time line window of FIG. 11.

FIG. 14 is an explanatory view illustrating the event list of FIG. 11.

FIG. 15 is an explanatory view further illustrating the event tool bar of FIG. 11.

FIG. 16 is an explanatory view illustrating the event input screen of the recorder for the non-real-time program.

FIG. 17 is a view showing one example of a voice editor used for editing the voice in the present invention.

FIG. 18 is an explanatory view illustrating a time table array, an event data structure, the structure of a start event array, the end event array constituting the event data structure, and the process of synchronizing and playing inputted respective events, if the contents of the lecture are loaded in the non-real-time reproducing program.

FIG. 19 is an explanatory view illustrating the process of managing the start and end times of each event by interlocking the time table, the event list, and the time line window.

FIG. 20 is a flowchart illustrating the algorithm of the multimedia player according to the present invention.

### DETAILED DESCRIPTION FOR PREFERRED EMBODIMENT

Hereinafter, a preferred embodiment of the present invention will be explained in detail with reference to the accompanying drawings.

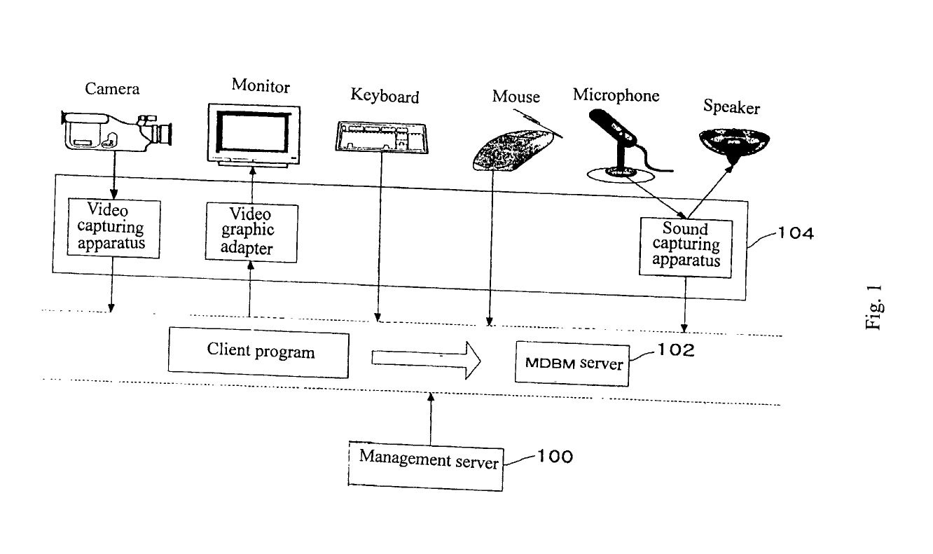

FIG. 1 shows an exemplary embodiment of the multimedia education management system according to the present invention. In operation, a user can connect with a management server, after passing through user authentication, then receive downloadable lecture notes. Thereafter, the user executes a client program by clicking a button for entrance to the lecture room to connect with the Multimedia Data Broadcasting Module (MDBM) server 102. Accordingly, all data transmitted from the user are sent to the MDBM server 102. Each of the peripheral devices, such as a camera, a monitor, a keyboard, a mouse, and a speaker, is controlled by the controlling device 104.

A client (or user) with the permission to speak can transmit his or her own appearance, which is captured through a camera to the MDBM server 102 in the course of the real-time lecture. Moreover, the client with the permission to speak can control the programs using the keyboard or mouse, generate events, and transmit the voice, which is inputted through a microphone and captured by the sound capturing apparatus to all the other clients via the MDBM server 102. The other clients who do not have the permission to speak can hear the voice of the other clients transmitted from the MDBM server through the speaker.

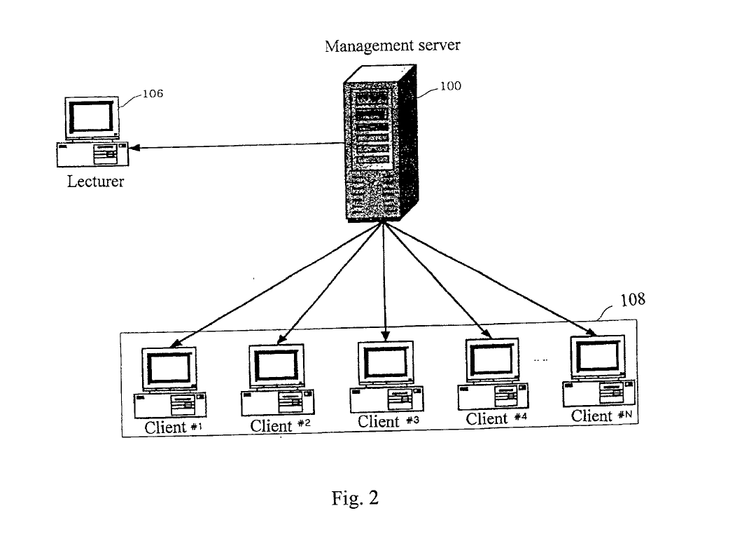

FIG. 2 is a view illustrating the function of the management server 100. The management server 100 stores image files for the lecture, and transmits the slide image files to a particular client's PC when it has received the transmission instructions of slide image files (or lecture notes) that are necessary for the lecture for the clients 108.

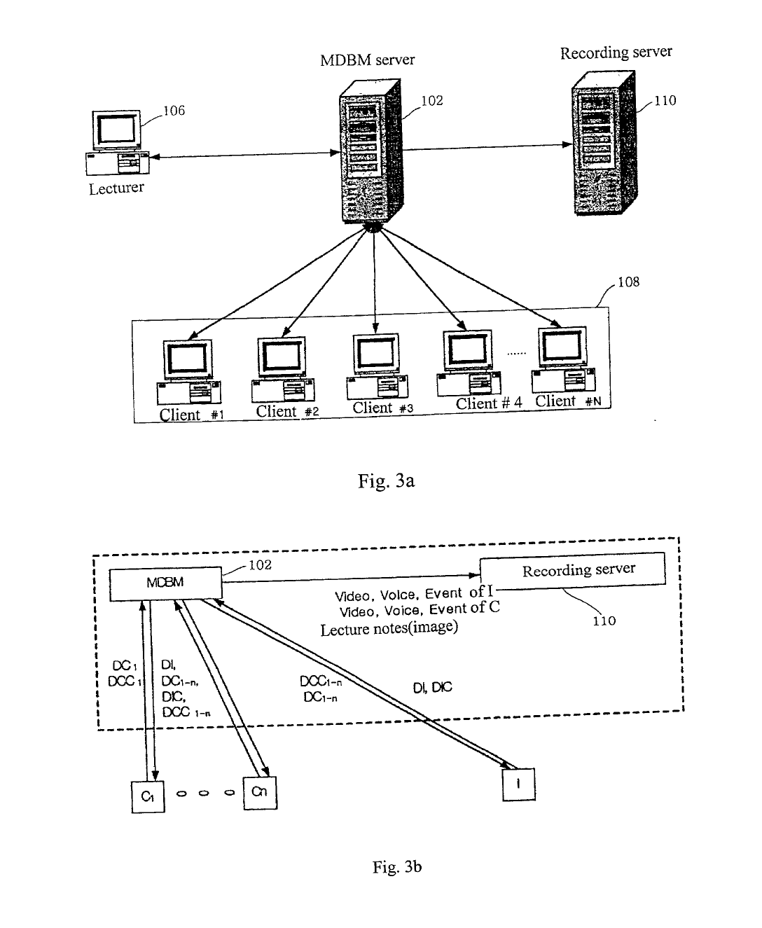

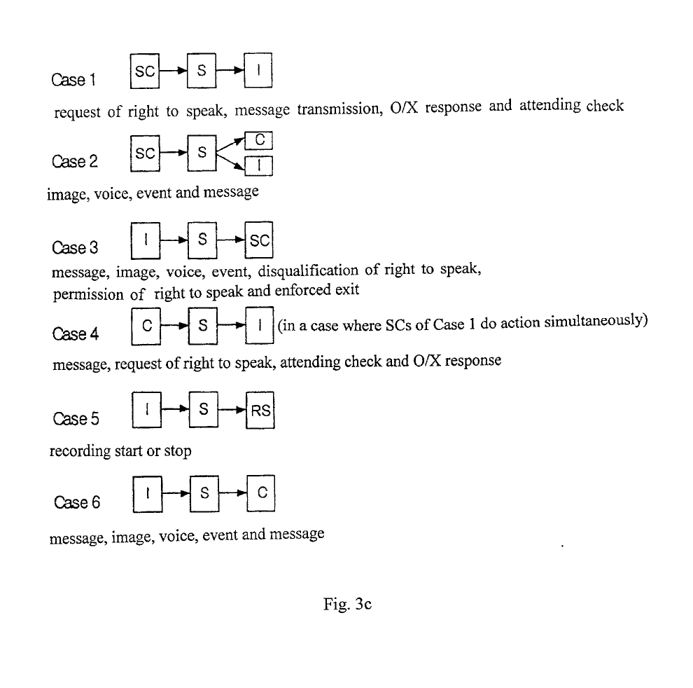

FIG. 3a is a view illustrating the connection relationship among the MDBM server, the recording server, and the respective clients.

The MDBM server 102 performs the function of receiving in real time the data that are transmitted by a client with the permission to speak, and then broadcasts the data to all the clients 108 connected thereto and the recording server 110. All broadcast data are inputted into the recording server 110. The recording server 110 performs the functions of automatically transforming the recorded lecture into a format capable of being used in a non real-time remote education program, and storing them in response to a recording signal through the MDBM server 102 from a lecturer 106.

FIG. 3b is a view illustrating the data patterns, which the MDBM server receives and transmits with the respective clients 108 and the recording server 110.

For reference, the type of data is as follows:

| Abbreviated | Name | Data type |
|---|---|---|
| I | Instructor | Lecturer |
| C | Clients | All clients connected to a server except the lecturer |
| SC | Specific Client | Specific client |
| S | Server | Server |
| RS | Recording server | Recording server |
| DI | Data of Instructor | Video/image, voice, text, and event of the lecturer |
| DC | Data of Client | Video/image, voice, text, and event of the client |
| | | (learner) |
| DIC | Data/Instructor/Control data | Permission to speak, enforced exit, tag transmission, |
| | | time data |
| DCC | Data/Client/Control data | Request to speak, tag request, time data |

Only the data of the person with the permission to speak among the lecturer I and clients C who are connected to the MDBM server 102 is broadcast to all clients and the recording server 110 through the MDBM server 102.

As shown in FIG. 3b, data from the lecturer I and all clients Cl. . . Cn are transmitted to the MDBM server 102, then the MDBM server 102 broadcasts all received data DI, DC to all the clients C1 . . . Cn, including the lecturer. Accordingly, the control signal that the lecturer and other clients transmit is also broadcast. The control data of all clients including the lecturer are broadcast to only the specific client through the MDBM server 102.

FIG. 3c is a view specifically illustrating the data pattern that the lecturer, client C, and client SC transmit. In this figure, all the data that are generated in each case are transferred via the MDBM server 102.

Case 1 shows an example in which a specific client SC transmits a request to speak, message transmission, O/X response to an inquiry, and attending check signal to a lecturer I.

Case 2 shows an example in which a specific client SC transmits data including an image, voice, event, and message to other clients C and lecturer I.

Case 3 shows an example in which a lecturer I transmits data including an image, voice, event, disqualification signal to speak, permission signal to speak, and enforced exit signal to a specific client SC.

Case 4 shows an example in which a number of clients C simultaneously transmit data, including a request to speak, an attending check signal, and an O/X response to an inquiry to the lecturer I.

Case 5 is a case in which a lecturer I issues the recording start/stop instructions to the recording server 108 to start or stop the recording of the lecture.

Case 6 shows an example in which a lecturer I transmits data including an image, voice, and event to all clients C.

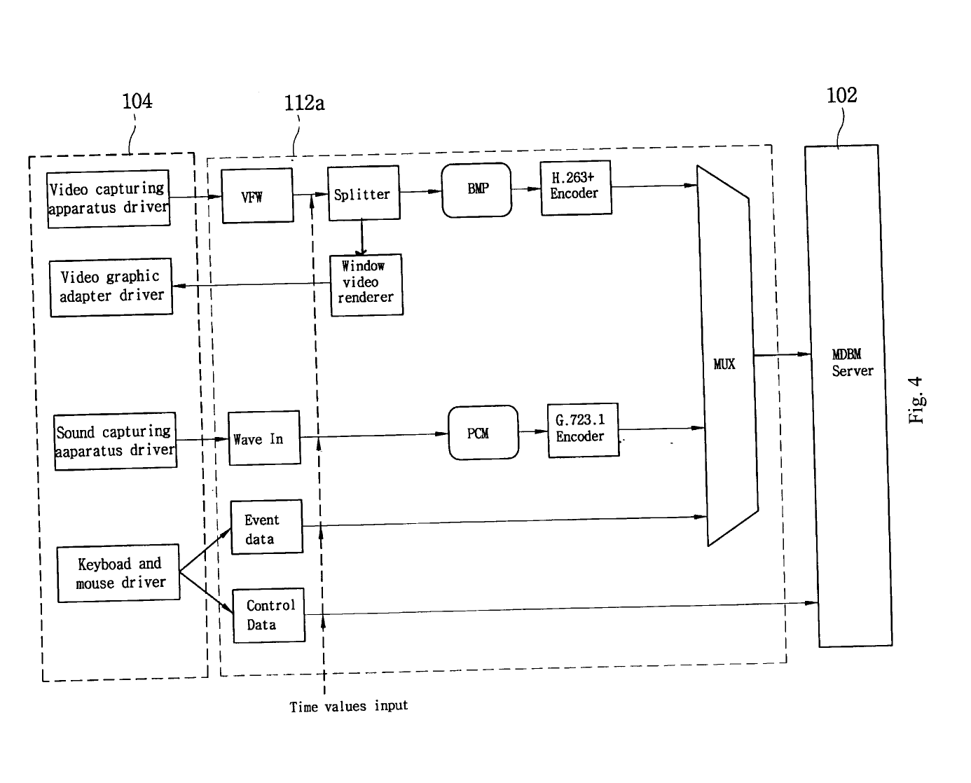

FIG. 4 is a view illustrating the process by which data inputted through a client side, i.e., a peripheral device controlling portion 104, are transmitted to the MDBM server via a client program portion 112a. Data inputted from the users is roughly classified into image data, voice data, event object data, and control data. The data processing method and sequence are as follows.

In operation, the image data inputted through a camera is image-captured by VFW (Video For Windows) and the data input time value is inputted for transmission to a splitter. The splitter duplicates the images captured at the VFW. Then, one is encoded into the BMP format by a H.263+ encoder and transmitted to a multiplexor (MUX), while the other is displayed into the motion video window of a client program through a window video renderer. Thus, the client can confirm its own captured image. It is noted that H.263+ is an international standard algorithm used in the compression of the motion video of multimedia communication service for video conference, video, telephone, and the like.

Meanwhile, the voice data inputted through a sound card is sampled by a Wave- In program to be transformed into PCM data. The PCM data is encoded using a G.723.1 encoder along with the time information at which data is inputted, then they are transmitted to the MUX. It is noted that H.723.1 is an international standard algorithm used in the compression of the voice part of multimedia communication service for video conference, video, telephone, and the like.

At the same time, the event data inputted through the keyboard or mouse are transmitted to the MUX along with the time information at which data is inputted. The control data inputted through the keyboard or mouse are also transmitted to the MDBM server along with the time information at which the data are inputted.

The MUX searches the time values appended to images, voices, and events data that are respectively inputted through the H.263+ encoder, G.723.1 encoder, and mouse. Then, the MUX extracts data having the same time value, combines such data into one, and appends the combined data into the original time value to transmit the data to the MDBM server 102.

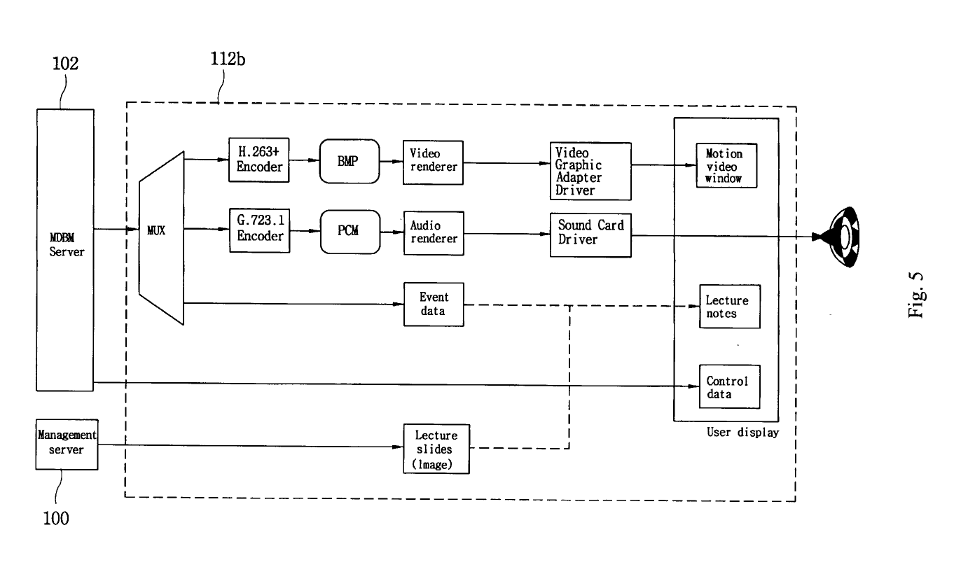

FIG. 5 is a view illustrating the process of broadcasting real-time lecture contents to the client side, in which the MDBM server 102 again transmits the data received from the MUX to the respective clients through the client program portion 112b and the peripheral device controlling section 104.

After the image and voice data transmitted from the MDBM server 102 have been demultiplexed in a demultiplexor (hereinafter referred to as “DEMUX”), the time values appended thereto are again appended to each of the image and voice data. Then, the image and voice data are decoded using a H.263+ decoder and a G.723.1 decoder, respectively. That is, the image data compressed by the H.263+ image encoder are decoded by the H.263+ decoder and transformed into BMP data. Then, the image data passes through the video renderer and shows on the motion video window. Further, the voice data compressed by the G.723.1 voice encoder are decoded using the G.723.1 decoder and transformed into the PCM data. Then, the voice data pass through the audio renderer and are transmitted to the sound card.

After the event data have been demultiplexed in the DEMUX, the time values appended thereto are again appended to the event data. Then, the event data are shown on the client's PC together with lecture slides (notes) already downloaded from the management server 100. The control data transmitted from the MDBM server 102 are also transmitted to the client's PC.

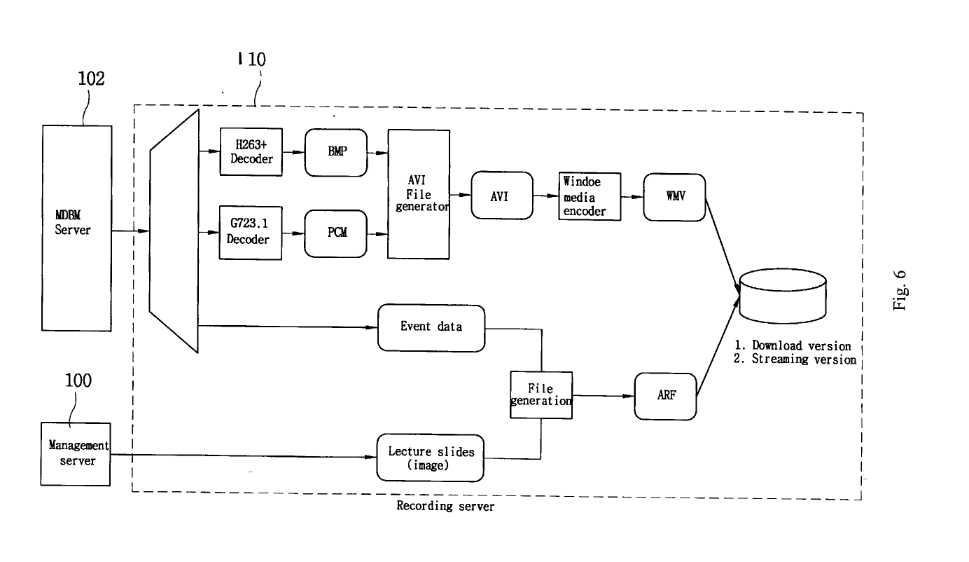

FIG. 6 shows the process in which a recording server 110 processes the data received from the MDBM server 102 and the management server 100.

The recording server 110 receives a lecture slide file from the management server 100, and the MDBM server 102 broadcasts the real-time lecture contents into the recording server 110. At this time, after the data received from the MDBM server 102 are demultiplexed in the DEMUX, the time values appended thereto are again appended to each of the images and voice data. Then, the image and voice data are decoded in the H.263+ decoder and the G.723.1 decoder, respectively That is, the image data encoded by the H.263+ image encoder are decoded using the H.263+ decoder and transformed into BMP data. The voice data encoded by the G.723.1 voice encoder are decoded by the G.723.1 decoder and transformed into the PCM data. Then, the BMP and PCM data are transformed into an AVI file using an AVI file generator and then into a WMV file by a windows media encoder.

In the meantime, the time values of the event data of the clients separated therefrom during the demultiplexing process are again appended thereto in the same manner as other demultiplexed data. Together with the image lecture file that has been previously transmitted from the management server and stored in the recording server, the time values of the event data of the clients are stored in the ARF file.

Finally, the WMV and ARF files are automatically stored in the recording server 110. Here, there are two types of storing models. A download version is a method of integrating and storing the WMV and ARF files, and a streaming version is a method of storing the WMV and ARF files separately to provide the WMV file with a large transmission capacity in the form of the streaming mode. Thus, a manager can select any one of the two modes in the non-real-time to store the data according to the selected mode.

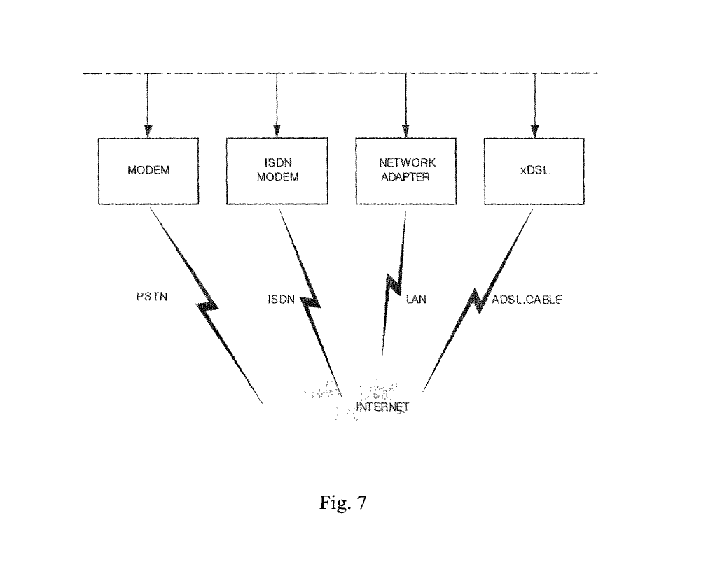

FIG. 7 shows a configuration showing how the client with real-time programs can connect with the MDBM server 102. The client can connect to the MDBM server 102 using various connection configurations, such a modem, an ISDN, a network and an xDSL.

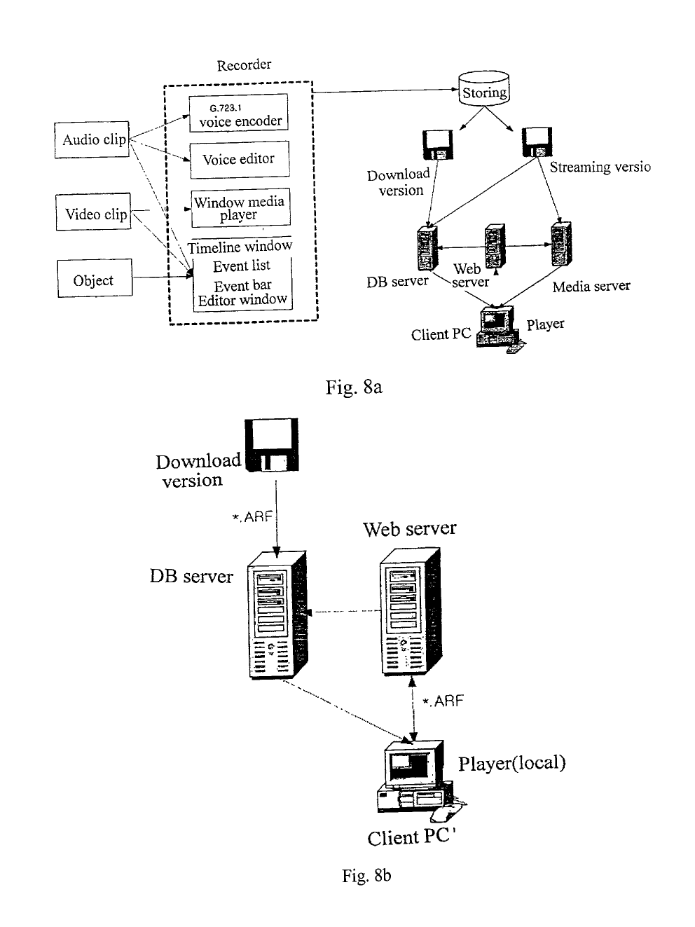

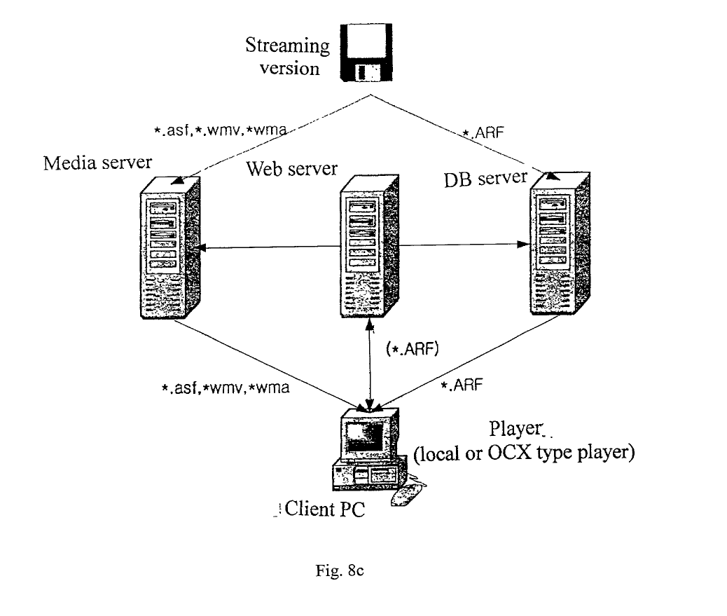

FIG. 8a is a view illustrating the method of producing and editing an audio clip by using the recorder of a lecture producing program, a method of inserting a motion video data file, and the process of storing a lecture file.

Method of Producing the Audio Clip

An audio (i.e., voice) can be simultaneously recorded through a microphone while inputting the events. In a case where the voice is synchronized, the voice is stored in the WAV file and subsequently encoded by the G.723.1 audio encoder. Thereafter, the voice is transformed into an ADT voice file format, and then automatically compressed and stored. Here, the ADT voice file format is a voice compression format, which has been developed by the applicant of the present application, 4C Soft Inc. That is, the ADT voice file format is a voice compression file format, in which the WAV file is transformed by a voice file transformer used for executing the encoding with the G.723.1 voice codec. It is used in the non-real-time lecturer and learner programs. However, it should be noted that the voice format applicable to the present invention is not limited to the ADT file, but it can be transformed into any other suitable format known to a person skilled in the art.

The audio clip can be produced using a previously recorded voice file. The voice file format used for the production of the audio clip is an ADT file format. In a case where the previously recorded voice file has another format, such as the WAV file, the voice file is transformed into the ADT voice format using the voice file transformer.

This method of producing the audio clip has an advantage in that the voice data file previously produced can be used without the need to input the voice simultaneously when the real-time lecture is being produced.

Method of Editing the Audio Clip The audio clip in the ADT file format produced is subject to editing and modifying operations, such as copying, moving and deleting, using the voice editor or time line window of the non-real-time lecture program.

Method of Inserting the Motion Video Data File

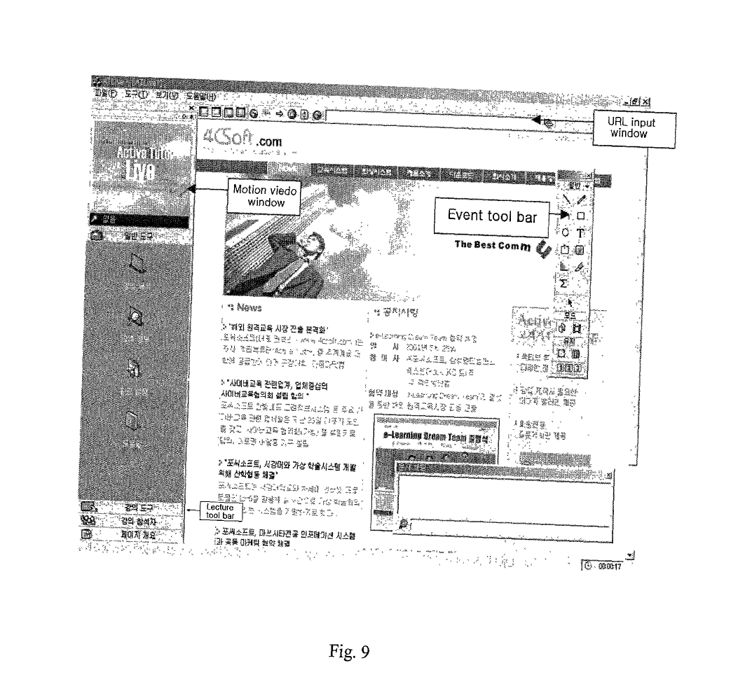

The motion video data file included in the lecture contents can be either played back on the motion video window by selecting the file, which is recorded in a file format supported in the window media player, through a “media file selection menu,” or inserted into the lecture slide through a “media event insert menu” in an event tool bar. In FIG. 8a, the video clip inserted through the media file selection menu is played back on the motion video window of FIG. 9.

Process of Storing the Lecture File

The lecture files are classified into the download mode and streaming mode. The producer of the lecture file can select and store the lecture file in the desired mode of the two modes.

FIG. 8b is a view illustrating the method of providing the lecture file produced in the download mode of FIG. 8a. In a case where the lecture file includes a media file, the media file is inserted into and appended to the lecture file in *.ARF format and is then stored in a DB server. When the client clicks the relevant lecture file (in *.ARF file format), a web server causes the lecture file stored in the DB server to be stored in the client's PC. After the download has been completed, the client plays back the lecture file by executing a local player installed within the client's PC.

FIG. 8c is a view illustrating the method of providing the lecture file produced in the streaming mode shown in FIG. 8b. In a case where the lecture file includes a streaming media file (i.e., *.asf, *.wmv, *.wma), the media file is stored in a separate media server. The remaining lecture file excluding the media file is stored, as the lecture file in *.ARF format, in the DB server. At this time, the lecture file contains the path of the relevant streaming media file. When the client clicks the relevant lecture file on the web server, the DB server in which the lecture file is stored either saves the lecture file onto the client's PC and plays back the lecture file by using the local player, or calls an OCX player on the web browser and plays back the lecture file. At this time, the players read the storage path of the relevant streaming media file from the lecture file and then connect with the media server in which the relevant media file is stored. Thus, a streaming service for the relevant media file can proceed.

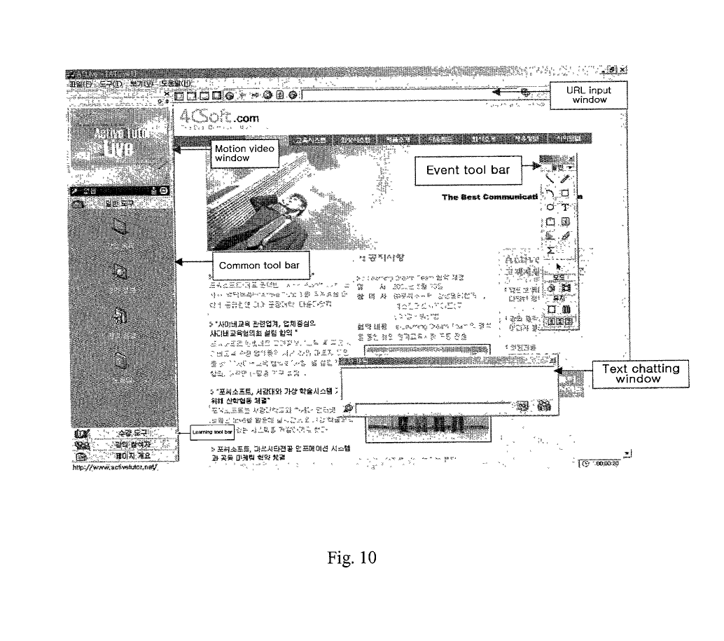

FIGS. 9 and 10 show user interfaces of real-time remote education programs, respectively.

Connection with the Real-time Remote Education Program

In a case where the existing management system has already been established, the user first connects with the web server of the existing management system, passes through user authentication (lecturer and learner qualifications), and connects with a lecture management system. If a lecture start button is clicked, the lecturer or learner program starts, and the lecture also starts.

Where the existing management system has not yet been established, the user immediately connects with the lecture management server and passes through the authentication process. Then, the remaining processes proceed in the same manner as before.

Functions of the Real-time Remote Education Program

1) Motion Videos and Voice Data

When the lecture begins, the lecturer's voice as well as a motion video screen of the lecturer (having now the permission to speak) are outputted onto the motion video window of the remote education program for learners. Where the learner requests permission to speak during the lecture, if the lecturer gives the learner permission to speak, the voice and motion video screen of the learner who has just received the permission to speak are outputted on the motion video window. If a camera has not been installed in the learner's terminal, only the voice is outputted.

2) Chatting Function

All the remote education programs for lecturers and learners have text chatting functions. Where the lecturer inputs the texts on the chatting input window and transmits them, messages are transmitted to all the clients who connect with the MDBM server 102. Where the learner inputs the texts on the chatting input window, the learner can selectively send the message to only the lecturer or to all the clients including the lecturer.

3) Inquiry and Reply Function

An inquiry function is used when the learner asks a question to the lecturer in the course of the real-time lecture, while a reply function is used when the lecturer responds to the question.

When the learner inputs inquiry contents using the inquiry function and transmits them, the inquiry contents are stored in a message box of the lecturer through the MDBM server 102. The lecturer can confirm the contents in the inquiry list box then respond to the respective inquiries using the reply function. Thus, the lecturer can understand the circumstances regarding the contents of the inquiries and replies.

4) Function of Requesting and Giving the Right to Speak

The remote education program for learners has the function of requesting permission to speak, by which the learner can request the lecturer the permission to speak in real time, while the remote education program for lecturers has the function of giving and canceling the permission to speak. When the learner has requested the permission to speak, the lecturer can confirm who has made the request from a list of the learners who attend the real-time lecture using the remote education program. Further, the lecturer can give the permission to speak to a specific requester at a desired time. At this time, through the MDBM server 102, the motion video of the specific requester to whom the permission to speak is given, is displayed on the motion video windows of all the clients and the voice of the specific requester is outputted. The voice and motion video of the learner can revert to the voice and motion video of the lecturer if the lecturer cancels the permission to speak.

5) Web Sync Function

In the course of the lecture, a web browser function can be performed and the sites related to the lecture contents can be searched in the real-time programs for lecturers and learners. If the client with the permission to speak presses a web sync activation button while the web browser is executed, the relevant URL is transmitted to all the clients who connect with the MDBM server 102. Therefore, identical web pages can be shared with all the clients.

6) Question-making and Reply Function

The lecturer can prepare quiz contents and transmit them to the learners in the course of the real-time lecture. Each of the learners can also transmit the answers or solutions using the reply function. In such a case, the lecturer can confirm the answers transmitted from the respective learners when confirming the lecture attendance.

7) Function of Confirming the Lecture Attendance

By pressing the “lecture attendant button” in the remote education program for lecturers, the lecturer can confirm the list of learners who currently attend the lecture in the course of the real-time lecture and confirm the contents of the quiz answers that have been transmitted from the learners.

8) Event Input Function.

The lecturer or learner who currently has the permission to speak can insert an event into the ongoing lecture notes in the course of the real-time lecture. The event inputted at this time is transmitted to all the clients who are currently connected with the MDBM server.

9) Real-time Lecture Recording Function

All data transmitted to the recording server through the MDBM server begin to record in real time from when the lecturer presses a recording button. Since the recorded data are stored in the form of the directly used non-real-time program, the data can again be modified and edited in the non-real-time program. Further, the data can be played back using the non-real-time player.

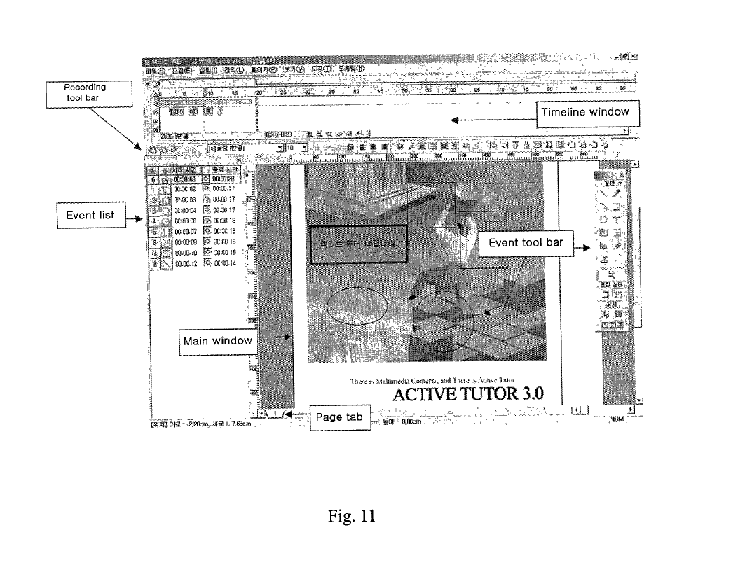

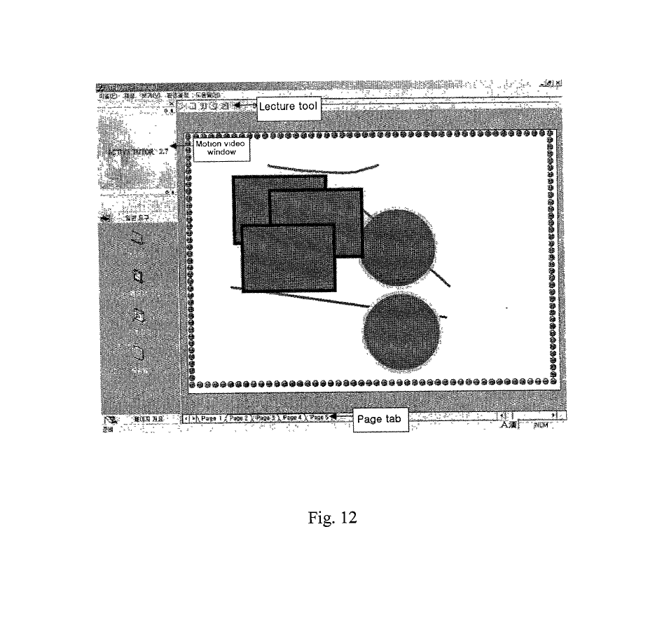

FIGS. 11 and 12 show a recorder and a player of the non-real-time remote education program, respectively. The recorder is an authoring program for producing and editing the remote education lecture contents in a non-real-time environment, while the player is a program for playing back the contents produced by the recorder.

Referring to FIG. 11, the recorder is comprised of a time line window for editing the playing time of the event used in the lecture, an event list window, a recording tool bar having recording tools, an event tool bar having the event editing tools, a main window screen, a page tab for displaying the lecture page, etc.

Referring to FIG. 12, the player is comprised of a lecture proceeding tool for controlling the progress of the lecture, a motion video window on which the motion videos are played back, menus, etc.

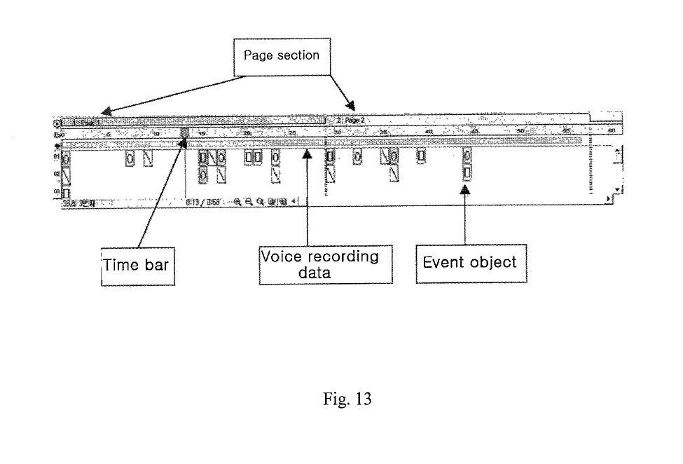

FIG. 13 is a view showing more specifically the time line window of FIG. 11, of which the detailed function is as follows:

The duration of how long each page is maintained is displayed in the time line window.

The event selected by the mouse can be deleted, copied, and moved at a desired position using the mouse, and the changed contents are directly applied to the event list.

A desired portion of the voice can be selected by choosing any region using the mouse, and editing such as deleting, coping and moving thereof can be made.

Where the event existed at a time zone when the user wishes to edit, the voice is included in a drag region together with the voice data. The event as well as the voice data can be simultaneously edited, i.e.—deleted, copied and moved. The changed contents are directly applied to the event list.

Where an event's end time has been set, a bar for indicating the event maintenance time appears beside an event object when the event object in the time line window is clicked once. By lengthening or shortening the bar after clicking the bar, the maintenance time is automatically adjusted and the end time of the event list window is set according to the changed maintenance time.

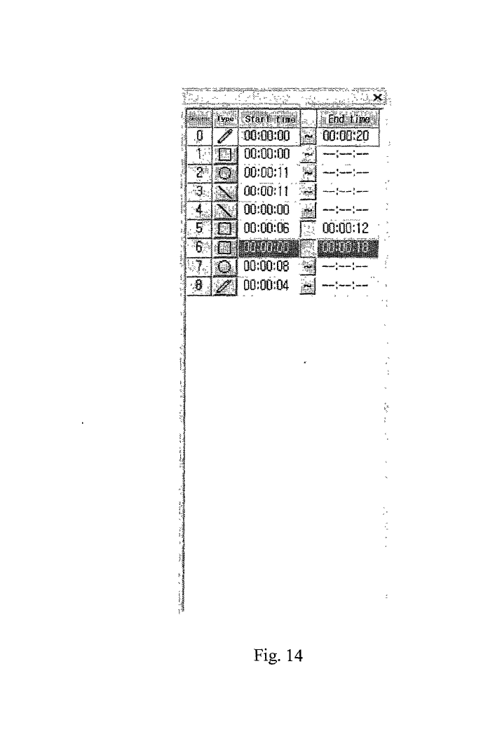

FIG. 14 is an enlarged view of the event list window of the recorder in FIG. 11, of which the detailed function is as follows:

The events that construct the lecture are classified as general event and media events, as described later. The general events include straight lines, free lines, arcs, rectangles, ellipses, text boxes, group boxes, figures, OLE objects, numerical formulas, etc. The media events include window media files, real media file, flash files, etc.

Further, a sequence section indicates the sequences of inputting the events; a type section indicates the types of events; a start time section indicates times when the events occur; and, an end time section indicates times when the relevant events will be terminated.

Method of Inputting the Events

The method of inputting the start time and end time of the event includes a method of selecting at the desired time of a desired event, which a user wishes to generate or terminate from the events on the event list window, in which the time has been already inputted while recording the lecture, and a method of directly inputting the start time and end time of the event which has been listed on the event list window.

1) Method of Directly Selecting the Event

When the recording starts, a time bar is shifted every second on the time line window and the time is counted. At this time, if the desired event is selected from the event list window when the user wishes to generate the event and a box having a shape of the event is pressed down, the time indicated by the time bar is automatically inputted as the start time of the selected event.

Further, if the user wishes to terminate any event after the time period of maintaining the event has passed, the time displayed on the time bar is automatically inputted as the end time of the selected event by the user's pressing down the button when the time bar has reached a desired time. Thus, the information on each of the start times and end times of event objects that can be varied while directly selecting the events is directly applied to the time line window as soon as changes thereof occur.

2) Method of Directly Inputting the Time

The time can be directly inputted by clicking the start time of the desired event on the event list window. The event with the time inputted therein will be generated at a relevant time.

If the user wishes to terminate the event at a desired time, the user can directly input the time by clicking the end time of the relevant event. Then, the event with the end time inputted therein will disappear from a relevant page at the inputted end time. Further, the information on each of the start times and end times of event objects that can be varied while directly inputting the time is directly applied to the time line window as soon as changes thereof occur.

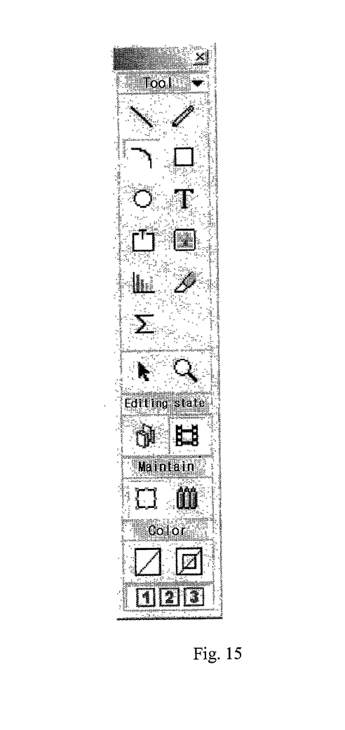

FIG. 15 shows an event tool bar by which the event of a non-real-time recorder of FIG. 11 can be selected and inputted. The detailed functions of the tool bar are as follows:

Event Input Number.

When the icon [symbol] is activated in the event input tool, relevant numbers are inputted in the correct order of the respective events whenever the events are inputted. These event numbers are constructed to make it easy to search out the events in a case where there is a multitude of events.

Editing State

A page editing mode and an event editing mode can be converted from each other by using the event input tool [symbol] . The event editing mode is a mode for inputting the event, in which the event can always be modified and the inputted event is displayed on the time line window.

The page editing mode is a mode for inputting the page contents, in which time values are not given to the event inputted therein. Thus, when the contents are retrieved from the non-real-time player, the event that has been edited in the page editing mode is called at the same time of loading the relevant page regardless of the time.

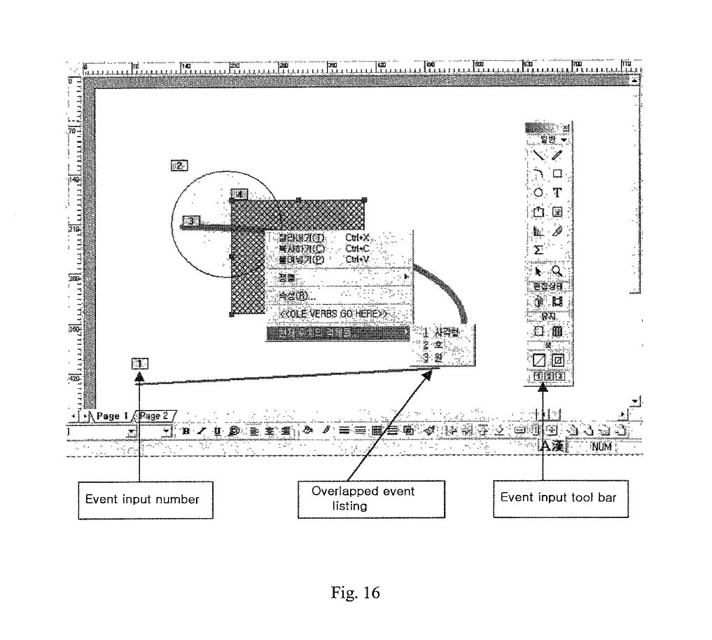

FIG. 16 shows a screen on which the event of the recorder of FIG. 11 is inputted. The detailed functions of the tool bar are as follows.

Objects at Current Positions

In a case where the event is inputted in non-real time in the event editing mode, the event that will be applied to the relevant page can be inserted beforehand into the page. By clicking the right button of the mouse twice, the window on which the event items included in the current position are listed together with event names thereof is displayed. It is considered difficult to move or edit the events in a case where the events overlap in adjacent positions. By selecting the desired event from the event names included in the contents of the window using the mouse, the event is automatically selected, so that moving, copying, deleting, etc. the selected event can be made.

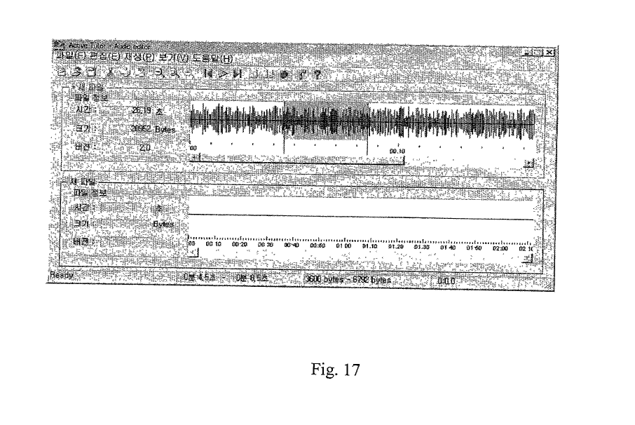

FIG. 17 shows an example of a voice editor for use in voice editing. The method of editing voice includes a method of using a built-in voice editor and a method of directly editing the voice on the time line window.

Method of Using the Voice Editor

The voice editor shown in FIG. 17 is used in the method. According to the method, a desired portion of voice data is selected, and copying, deleting, and moving the selected portion can be made. Since a portion of the voice data to be modified is again recorded in a lower section of the voice editor while the original voice data are put in an upper section of the voice editor, an operation of the voice editing by comparing the two voice data files with each other can be made.

Method of Using the Time Line Window

Where only voice is to be edited, the region where the user wishes to edit is set within the time line window, only the portion of the voice data is then selected, and the operations such as editing, modifying, and deleting the selected portion data can be finally made. If the user wishes to simultaneously perform the operations such as deleting, coping, and moving all included events at a time corresponding to the voice data in the edited portion, the user can edit the event objects on the time line window together with the voice data by including the event objects into the voice editing region.

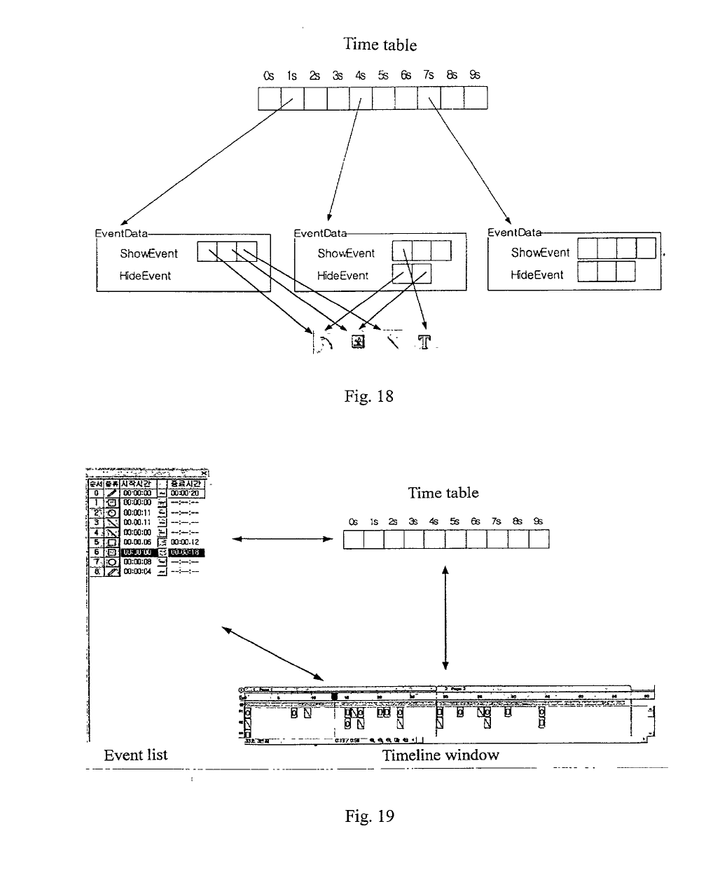

FIG. 18 shows the process of synchronizing and playing back the respective events that have been inputted when taking lectures.

The time values of entire lectures of manufactured lesson plans, the time values when the respective events occur and the time values when the events are terminated are all stored in a *.ARF file. When the player is executed, an entire lecture period is first read as a unit of one second. Then, an array of timetables corresponding to a second unit size of the read period is generated. Finally, all data in the array are initialized as Null values.

Next, the time values of all event objects inputted in the *.ARF file are read. At this time, if there are no events that are generated or terminated, the data of the timetable array at the relevant time are maintained as first set Null values. On the other hand, if there are any times of the events that are generated or terminated, the EventData structure is automatically generated at the relevant time and the addresses of the generated EventData structure are stored in array values within the time table array. The EventData structure is comprised of two arrays, ShowEvent and HideEvent. Among the events corresponding to the times when the EventData structure is designated, the object addresses of the events that will be generated, terminated, and stored in the ShowEvent array and HideEvent array, respectively.

After searching all the time values of the respective events and the construction of the EventData structure have been completed, the timetable is searched from 0 second to the end time. In a case where any of the values within the timetable array are Null, it goes into the next time. In a case where the values are not Null, the relevant EventData structure is called. At this time, the ShowEvent array and HideEvent array are searched, and the relevant events are consequently generated or terminated.

FIG. 19 shows how each of the start and end times of the events are managed by interlocking the timetable, and a view of the event list window and the time line window with each other.

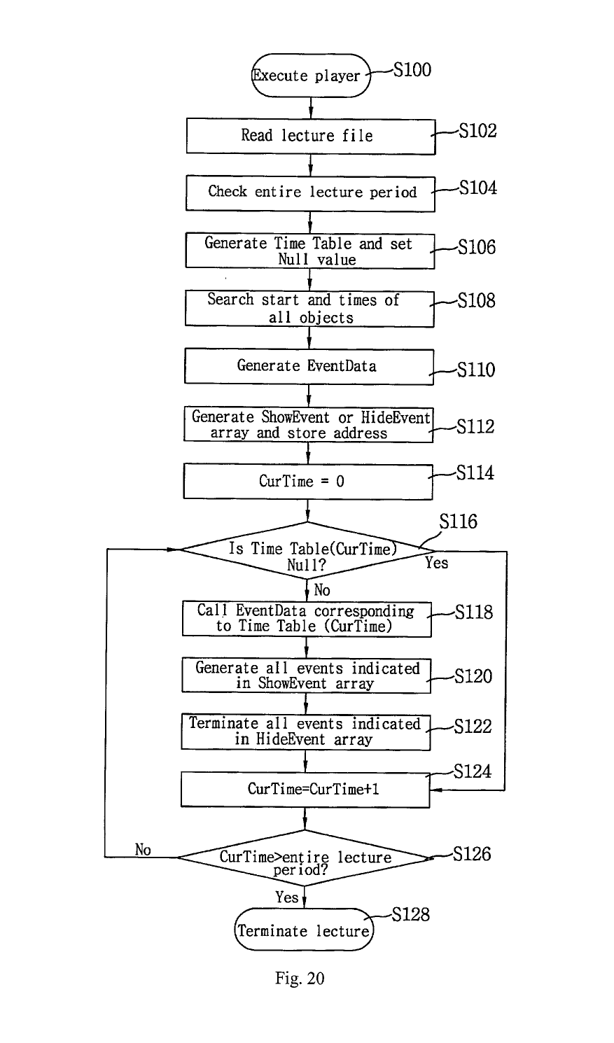

FIG. 20 is a flowchart illustrating an algorithm of the multimedia player according to the present invention.

First, the player is executed (S100), and the desired lecture file (*.ARF) is then opened (S 102).

The entire lecture period of the lecture file is checked (S 104).

The timetable array having a size corresponding to the entire lecture period is generated and all the data within the timetable array are set to be Null (SI 06).

The start and end times of all the pages and objects within the lecture file are searched (S108).

When there are events to be generated or terminated later, the EventData structure is generated (S106).

The ShowEvent or HideEvent array is generated into the EventData structure that has been generated when there are events to be generated or terminated, and the addresses of the relevant events are stored therein (SI 12).

Next, the current time CurTime is set to zero (S114).

If any of the pages are clicked, the generation time of the selected page is stored as the current time CurTime.

It is then checked whether the value of the time table (current time) Time table (CurTime) is Null (S116). At this time, if the value of the timetable (current time) Time table (CurTime) is not Null, the EventData structure corresponding to the time table (current time) Time table (CurTime) is called (S118). Further, all the events corresponding to the addresses stored in the ShowEvent array within the EventData structure are generated (S120), all the events corresponding to the addresses stored in the HideEvent array within the EventData structure are terminated (S122), and the current time CurTime is increased by one (S124).

Next, it is checked whether the current time CurTime exceeds the entire lecture period (S126). If the current time CurTime exceeds the entire lecture period, the lecture is terminated (S128). Otherwise, steps S116 to S124 are repeated.

According to the present invention described above, the following advantages can be expected and obtained.

1. The voice is recorded beforehand and stored as a WAV or ADT file, and the voice file is designated in the recorder before recording. Then, when the recording starts, only the event input operation can be made without performing the voice recording operation simultaneously. Therefore, the contents production is still more efficient than the conventional one.

2. The event and voice data file inputted in non-real time can be modified or edited. Therefore, if the user wishes to modify or edit the conventional contents, only desired portions thereof can be selectively edited without producing the contents again from the beginning.

3. Since the relevant event is generated at the time when the producer wishes by assigning the start and end time values to the respective events, the producer can adjust the start time of the event without handling the contents personally. Further, the producer can utilize several events at adjacent locations by assigning the start time of the next event after the conventional event has been completed.

4. Since all the lists of the events that are positioned at a pointer location are constructed to be shown by double-clicking the right button of the mouse at a location where several events are overlapped with each other, the method of modifying and editing the event can be improved.

5. As the relevant homepages can be linked to the respective events, the web browser can be executed by simply selecting the event at any time while the contents are being executed. Thus, the home page address can indicate that the producer has been assigned to the event attribute.

6. Since all the events including the voices, motion videos, and pages that construct the contents are synchronized and combined with each other to have the start and end time values thereof, any portions of the contents can be repeatedly played back at any time by using the time bar.

7. The motion videos, voices, events, and contents of the lecture notes recorded in the process of the real-time lecture are recorded and stored intact, then they can be reloaded on the non-real-time program for the lecturer. Therefore, the motion videos, voices, events and contents of the lecture notes can be modified and edited in the same manner as the conventional non-real-time method of modifying the contents.

The present invention is not limited to the above descriptions, but the system and steps can be added or subtracted according to the lecture contents, system configuration, the user's choice or the like. Therefore, it should be understood by a person skilled in the art that these additions and subtractions, various changes and modifications may be made without departing from the spirit and scope of the invention as defined in the following claims.

What is claimed is:

1. A multimedia electronic education system, comprising:
a plurality of client devices;
a recording server for recording a real-time lecture, for automatically converting said recorded lecture into a format capable of being used for a non-real-time remote program, and for storing said converted lecture;
an MDBM (Multimedia Data Broadcasting Module) server for connecting said plurality of client devices to each other and for broadcasting data to be transferred during said real-time lecture to all said client devices and said recording server; and, a management server for transmitting lecture notes to said client devices and said recording server and for performing user authentication.

2. The system as claimed in claim 1, wherein each of said client devices includes an image input portion (VFW; Video For Windows) for capturing an image inputted through a camera, for automatically inputting data input time values thereto, and for transmitting them to a splitter portion, said splitter portion operative for copying said captured image, for transmitting one of said copied images to a MUX (Multiplexor), and for displaying the other of said copied images on the video window of a client program through a window video renderer; a voice converting portion for sampling voice data inputted through a sound card and for converting said sampled voice data together with said data input time values into voice data of a different format; and, said MUX for operative multiplexing said captured image data, said converted voice data, and event data inputted through a keyboard or mouse and transmitting them to said MDBM server.

3. The system as claimed in claim 2, wherein said MUX searches the time values appended to said inputted image, said voice and event data, extracts data having identical time values, incorporates said extracted data into a piece of data, appends original time values to said incorporated data, and subsequently transmits them together with control data to said MDBM server.

4. The system as claimed in claim 2, wherein each of said client devices includes a DEMUX (demultiplexor) for demultiplexing data transmitted from said MDBM server into said captured image data, said converted voice data, and said event data; an image output portion for displaying said image data on said video window; a voice output portion for transmitting said voice data to said sound card; and, a lecture output portion for displaying said event data together with said lecture notes previously downloaded by said management server on said client device.

5. The system as claimed in claim 4, wherein said DEMUX performs said demultiplexing by appending original time values to said inputted image, voice, and event data again.

6. The system as claimed in claim 1, wherein said recording server processes data received from said MDBM and said management servers, wherein said data received from said MDBM server are demultiplexed into image data, voice data, and event data so that said image and voice data are incorporated and converted into a predetermined multimedia file for transmission, which in turn is stored, and wherein said event data are synchronized with an image lecture file received by and stored in said management server so that they are stored as a lecture file.

7. The system as claimed in claim 6, wherein said multimedia file and lecture file are subsequently incorporated into one file, which in turn is stored in a separate storage media.

8. The system as claimed in claim 6, wherein said multimedia file and lecture file are stored in a separate storage media, and said lecture file includes information on an address in which said multimedia file is stored.

9. The system as claimed in claim 7, wherein said incorporated multimedia file and lecture file can be played back in said client device.

10. The system as claimed in claim 8, wherein said lecture file can be played back in said client device, and upon playing back thereof, said client device reads said multimedia storing address included in said lecture file and receives said multimedia file from said multimedia storing address.

11. A method for generating a lecture file using the recorder of a lecture-producing program by a lecturer, comprising the steps of:
preparing an event list while counting the lecture time;
if a lecturer's voice is inputted, generating a voice file together with information on said counted lecture time;
upon the input of an event, storing start or end time and type of said event in said event list; and,
synchronizing said voice file with events registered in said event list according to the information on said lecture time and for separately or integrally storing said voice file and said events.

12. The method as claimed in claim 11, wherein said step of generating said voice file includes the step of incorporating information on said lecture time into said previously stored voice file.

13. The method as claimed in claim 11, wherein said start or end time of said event is directly inputted by said lecturer.

14. The method as claimed in claim 11, wherein said event includes a line, a circle, a box, an OLE object, and a multimedia file.

15. The method as claimed in claim 11, wherein said event list includes information on a plurality of events at one start or end time.

16. The method as claimed in claim 15, wherein if there is said information on the plurality of events at the same start or end time, said information on the plurality of events further includes additional identification information and can be identified at the same start or end time according to said additional identification information, and wherein the selection of said additional identification information allows relevant events to be displayed.

17. The method as claimed in claim 16, wherein said recorder comprises a time line window for editing said start and end times of said lecture and events; a recording tool bar for providing recording tools; an event list window for editing said start and end times of each event; an event tool bar for providing event editing tools; and, a main window screen on which lecture notes and said events are displayed.

18. The method as claimed in claim 17, wherein said start and end times of said event inputted through said event list window can be modified by adjusting said start and end times of said event displayed on said time line window.

19. The method as claimed in claim 18, wherein said start and end times of said event displayed on said time line window are interlocked with said start and end times of said event inputted through said event list window.

20. A multimedia electronic education method, comprising the steps of:
loading a lecture file and checking the overall lecture time;
generating a time table array having a size corresponding to said overall lecture time;
searching start and end times of all events in an event list;
generating an event data structure in said time table array corresponding to periods of said event's existence according to said start and end times of all said events, storing the addresses of said event data structure in said time table array, generating a start and end event array in said event data structure, and storing relevant start and end event addresses in said start and end event array; and,
if there are said addresses of said event data structure in said time table array corresponding to said lecture time while increasing said lecture time, loading an event of relevant start and end event addresses stored in said start event array and said end event array in said event data structure, and starting or ending said event.

21. The method as claimed in claim 20, wherein said time table array corresponding to a period during which no said event is designated as “Null.”

22. The method as claimed in claim 20, further comprising the step of reproducing said voice file according to said increased lecture time.
